(19) United States
(12) Patent Application Publication
(10) Pub. No.: US 2014/0132259 A1
(43) Pub. Date: May 15, 2014

(54) NMR METHOD TO DETERMINE GRAIN SIZE DISTRIBUTION IN MIXED SATURATION

(71) Applicant: SCHLUMBERGER TECHNOLOGY CORPORATION, Sugar Land, TX (US)

(72) Inventor: Yi-Qiao Song, Newton, MA (US)

(73) Assignee: Schlumberger Technology Corporation, Sugar Land, TX (US)

(21) Appl. No.: 13/675,649

(22) Filed: Nov. 13, 2012

(51) Int. Cl. G01V 3/14

(52) U.S. Cl. CPC G01V 3/14
USPC 324/303

(57) ABSTRACT

A method for determining particle size distribution of a subsurface rock formation having pore spaced filled with at least two different fluids using measurements of at least one nuclear magnetic resonance property thereof made from within a wellbore penetrating the rock formation includes determining a distribution of nuclear magnetic relaxation times from the measurements of the at least one nuclear magnetic resonance property. A fractional volume of the pore spaces occupied by each of the at least two fluids is determined. A surface relaxivity of the rock formation for portions of the rock pore spaces occupied by each of the at least two fluids is determined from a measurement of a formation parameter. The relaxation time distribution and the surface relaxivities are used to determine the particle size distribution.

### CROSS-REFERENCE TO RELATED APPLICATIONS

Not applicable.

### STATEMENT REGARDING FEDERALLY SPONSORED RESEARCH OR DEVELOPMENT

Not applicable.

### BACKGROUND

This disclosure relates generally to the field of analysis of subsurface formation particle size distribution. More specifically, the disclosure relates to methods for using nuclear magnetic resonance (NMR) measurements to determine distribution of formation particle size when pore spaces of the formation are saturated with mixed composition, immiscible fluids, e.g., oil, gas and/or water.

U.S. Patent Application Publication No. 2010/0315081 filed by Chanpura et al. describes a method for determining particle size distribution of subsurface formations penetrated by a wellbore by making measurements of NMR relaxation times (either transverse or longitudinal) and NMR diffusion properties. The method disclosed in the '081 publication uses the assumption that the pore spaces of the formation being evaluated are saturated with water. There are situations where such conditions are not present when the formation is evaluated by NMR measurements. There exists a need for a method for determining formation particle size distribution wherein the pore spaces of the formation are not completely saturated with water.

### SUMMARY

One aspect of the disclosure is a method for determining particle size distribution of a subsurface rock formation having pore spaced filled with at least two different fluids using measurements of at least one nuclear magnetic resonance property thereof made from within a wellbore penetrating the rock formation includes determining a distribution of nuclear magnetic relaxation times from the measurements of the at least one nuclear magnetic resonance property. A fractional volume of the pore spaces occupied by each of the at least two fluids is determined. A surface relaxivity of the rock formation for portions of the rock pore spaces occupied by each of the at least two fluids is determined from a measurement of a formation parameter. The relaxation time distribution and the surface relaxivities are used to determine the particle size distribution.

Other aspects and advantages will be apparent from the description and claims which follow.

### BRIEF DESCRIPTION OF THE DRAWINGS

FIG. 1A shows an example wireline conveyed well logging instrument.

FIG. 1B shows an example logging while drilling (LWD) instrument system.

FIG. 2 shows an example computer system.

### DETAILED DESCRIPTION

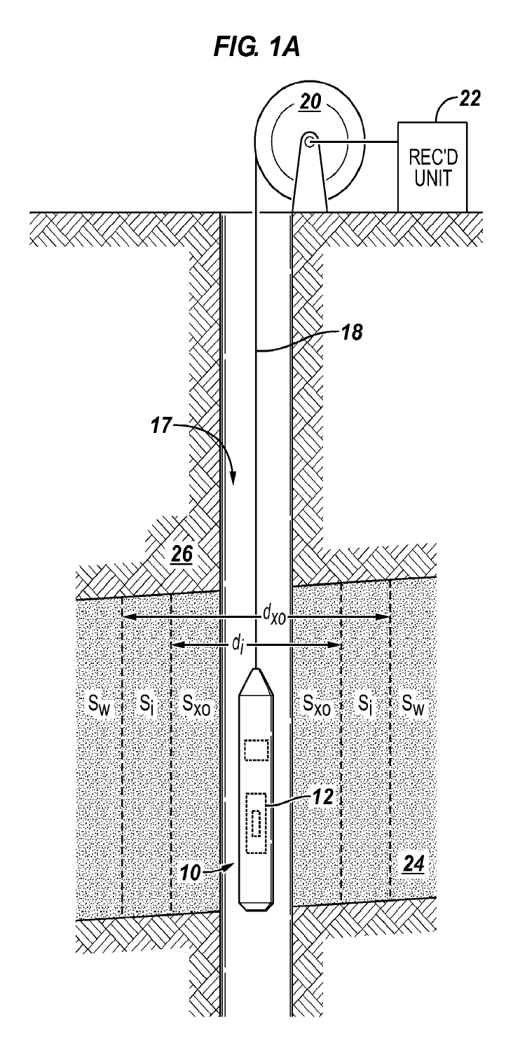

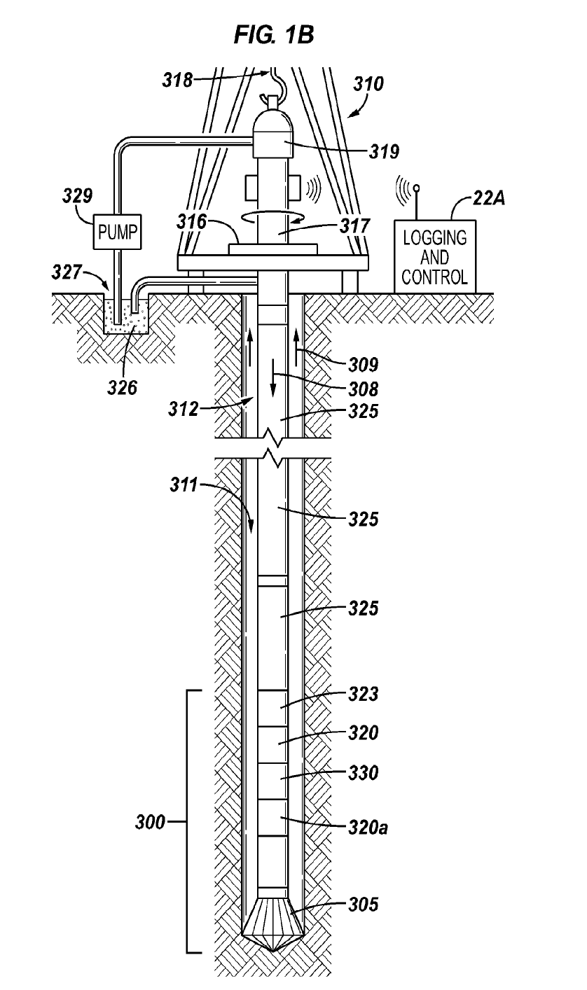

FIG. 1A shows an example nuclear magnetic resonance (“NMR”) wireline well logging instrument 10 disposed in a wellbore 17 drilled through subsurface rock formations 26, 24. The instrument 10 is attached to one end of an armored electrical cable (“wireline”) 18. The cable 18 may be extended into the wellbore 17 and withdrawn therefrom by a spooling device such as a winch 20 of types well known in the art. The cable 18 includes one or more insulated electrical conductors and, may include one or more optical fibers to communicate signals between the instrument 10 and a recording unit 22 disposed at the Earth's surface. The recording unit 22 may include a computer (not shown separately) having a screen or printer type data display, input controls and a data recording device for storage of signals (e.g., NMR measurements) communicated from the well logging instrument 10, as well as for storing or displaying calculated results made from NMR measurements made by the instrument 10.

The NMR instrument 10 includes a magnet 12 for inducing a static magnetic field in the formations 24, 26 having a predetermined spatial distribution of magnetic field amplitude. As the instrument 10 is moved along the interior of the wellbore 17, nuclei in the formations surrounding the wellbore are magnetically polarized along the direction of the magnet's 12 field. The instrument 10 also includes an antenna for inducing radio frequency (“RF”) magnetic fields in the formations, and for detecting radio frequency signals induced by NMR phenomena excited in the formations by the static and RF magnetic fields. The particular portion of the formations adjacent to the wellbore from which the NMR signals originate depends on, among other factors, the spatial amplitude distribution of the static magnetic field and the RF frequency used to induce NMR phenomena in the formations. Some magnets may induce a region of substantially homogeneous field amplitude in a particular region in the formations; other types of magnets may induce static fields having a selected amplitude gradient in a particular region of interest. For certain types of measurements, e.g., diffusion, homogeneous field magnets may be supplemented by an electromagnet (not shown) configured to impart a selected magnitude gradient field superimposed on the static homogenous field.

Some formations, for example the one illustrated at 24 in FIG. 1A may be permeable and/or contain movable hydrocarbon in the pore spaces thereof. Proximate the wall of the wellbore 17, a portion of the formation 24 may be subjected to sufficient infiltration of the liquid phase of a fluid (“drilling mud”), called “mud filtrate”, used to drill the wellbore 17, that substantially all of the mobile connate fluids in the pore spaces of the formation 24 are displaced by the mud filtrate. Depending on, for example, the fractional volume of pore space (“porosity”) of the formation 24, and the filtrate characteristics of the drilling mud, the mud filtrate will fully displace all the mobile connate fluids to a depth represented by dxo in FIG. 1A. The foregoing is referred to as the diameter of the “flushed zone.” Partial displacement of connate fluid is shown extending to a diameter represented by di, which is used to represent the diameter of the “invaded zone.” At a certain lateral depth in the formation 24, beyond the diameter of the invaded zone, connate fluid is substantially undisturbed. A quantity of interest in determining possible fluid production in from the formation is the fractional volume of the pore space that is occupied by water (and its complement assumed to be occupied by hydrocarbons). In the uninvaded zone, such fractional volume, called “saturation”, is represented by Sw. Invaded zone and flushed zone water saturations are represented, respectively, by Si and Sxo.

The example instrument shown in FIG. 1A is only for purposes of explaining the source of measurements that may be used with a method according to the invention and is not intended to limit the configurations of NMR well logging instrument that may be used to provide measurements for the method of the present invention. Further, reference to portions of formations that contain hydrocarbon are only for purposes of illustrating general principles of NMR well logging; as will be explained below, certain measurements of NMR properties may be made in formations known to be fully water saturated to simplify calculations of formation properties made from the NMR measurements.

FIG. 1B illustrates a wellsite system in which an NMR well logging instrument can be conveyed using a drill string or other pipe string for measurement during the drilling of the wellbore, or during other pipe string operations associated with the construction of a wellbore such as circulating and “tripping.” The wellsite can be onshore or offshore. In the example system of FIG. 1B, a wellbore 311 is drilled through subsurface formations by rotary drilling in a manner that is well known in the art. Other examples of NMR instruments applicable to the present invention can be used in connection with directional drilling apparatus and methods. Accordingly, the configuration shown in FIG. 1B is only intended to illustrate a possible source of NMR measurements and is not intended to limit the scope of the present disclosure.

A drill string 312 is suspended within the wellbore 311 and includes a bottom hole assembly (“BHA”) 300 proximate the lower end thereof. The BHA 300 includes a drill bit 305 at its lower end. The surface portion of the wellsite system includes a platform and derrick assembly 310 positioned over the wellbore 311, the assembly 310 including a rotary table 316, kelly 317, hook 318 and rotary swivel 319. The drill string 312 is rotated by the rotary table 316, which is itself operated by well known means not shown in the drawing. The rotary table 316 engages the kelly 317 at the upper end of the drill string 312. The drill string 312 is suspended from the hook 318. The hook 318 is attached to a traveling block (also not shown), through the kelly 317 and the rotary swivel 319 which permits rotation of the drill string 312 relative to the hook 318. As is well known, a top drive system (not shown) could alternatively be used instead of the kelly 317 and rotary table 316 to rotate the drill string 312 from the surface. The drill string 312 may be assembled from a plurality of segments 325 of pipe and/or collars threadedly joined end to end.

In one example, the BHA may include an instrument known as a dipole shear sonic imager (“DSI”, which is a trademark of Schlumberger Technology Corporation, Sugar Land, Tex.). Measurements from the DSI instrument may be used to estimate a formation parameter called surface relaxivity as will be explained further below. The DSI instrument may also be conveyed through the wellbore by any other means known in the art, for example the wireline conveyance shown in FIG. 1A.

In the present example, the surface system further includes drilling fluid (“mud”) 326 stored in a tank or pit 327 formed at the wellsite. A pump 329 delivers the drilling fluid 326 to the interior of the drill string 312 via a port in the swivel 319, causing the drilling fluid 326 to flow downwardly through the drill string 312 as indicated by the directional arrow 308. The drilling fluid 326 exits the drill string 312 via water courses, or nozzles (“jets”) in the drill bit 305, and then circulates upwardly through the annulus region between the outside of the drill string and the wall of the borehole, as indicated by the directional arrows 309. In this well known manner, the drilling fluid 326 lubricates the drill bit 305 and carries formation cuttings up to the surface, whereupon the drilling fluid 326 is cleaned and returned to the pit 327 for recirculation.

The bottom hole assembly 300 of the illustrated example can include a logging-while-drilling (LWD) module 320, a measuring-while-drilling (MWD) module 330, a steerable directional drilling system such as a rotary steerable system and/or an hydraulically operated motor such as a steerable motor, and the drill bit 305.

The LWD module 320 is housed in a special type of drill collar, as is known in the art, and can contain one or a plurality of known types of well logging instruments. It will also be understood that more than one LWD and/or MWD module can be used, e.g. as represented at 320A. (References, throughout, to a module at the position of LWD module 320 can alternatively mean a module at the position of MWD module 320A as well.) The LWD module 320A typically includes capabilities for measuring, processing, and storing information, as well as for communicating with the surface equipment. In the present embodiment, the LWD module 320 includes an NMR measuring instrument. An example configuration of such instrument is explained above with reference to FIG. 1A.

The MWD module 330 is also housed in a special type of drill collar, as is known in the art, and can contain one or more devices for measuring characteristics of the drill string and drill bit. The MWD module 330 further includes an apparatus (not shown) for generating electrical power for the downhole portion of the wellsite system. Such apparatus typically includes a turbine generator powered by the flow of the drilling fluid 326, it being understood that other power and/or battery systems may be used while remaining within the scope of the present invention. In the present example, the MWD 330 module can include one or more of the following types of measuring devices: a weight-on-bit measuring device, a torque measuring device, a vibration measuring device, a shock measuring device, a stick slip measuring device, a direction measuring device, and an inclination measuring device.

The foregoing examples of wireline and drill string conveyance of a well logging instrument are not to be construed as a limitation on the types of conveyance that may be used for the well logging instrument. Any other conveyance known in the art may be used, including without limitation, slickline (solid wire cable), coiled tubing, well tractor and production tubing.

A recording unit 22A may be disposed at the surface and may include data acquisition, recording, input, control and display devices similar to those of the recording unit shown at 22 in FIG. 1A.

In an example method according to the invention, measurements of nuclear magnetic resonance (“NMR”) properties of subsurface formations may be made at one or more lateral depths into the formations adjacent to the wellbore. A NMR instrument, as explained above with reference to FIGS. 1A and 1B, can be moved along a wellbore drilled through subsurface formations. As explained with reference to FIG. 1A, NMR measurement made by the instrument includes prepolarizing nuclei in the formations by imparting a static magnetic field in the formations. The static magnetic field has known spatial amplitude distribution and known spatial gradient distribution. NMR phenomena are excited in the formations by applying a radio frequency (“RF”) magnetic field to the prepolarized nuclei. A frequency of the RF magnetic field is selected to excite NMR phenomena in selected types of nuclei and within particular volumes in the formations (“sensitive volumes”). As is known in the art, the spatial position of the sensitive volume depends on the spatial distribution of the amplitude of the static magnetic field, the gyromagnetic ratio of the selected nuclei and the frequency of the RF magnetic field. Electromagnetic fields resulting from the induced NMR phenomena are detected and analyzed to determine NMR properties of the formations within the sensitive volumes. Such properties may include distribution of longitudinal and transverse relaxation times and distributions thereof (T1 and T2, respectively) and diffusion constants (D) of the various components of the formations. The foregoing parameters may be used to estimate, as non limiting examples, the total fractional volume of pore space (“total porosity”) of the various subsurface formations, the bulk volume of “bound” water (water that is chemically or otherwise bound to the formation rock grains, such as by capillary pressure, and is therefore immobile), the fractional volume of the pore space occupied by movable water (“free water”) and the fractional volume of the pore space occupied by oil and/or gas. As will be further explained below, the same NMR parameters may be used according to the present invention to estimate particle size distribution (“PSD”) of certain subsurface rock formations, as well as a parameter known as surface relaxivity.

In one example, NMR measurements may be made using an instrument identified by the trademark MR SCANNER, which is a trademark of Schlumberger Technology Corporation, Sugar Land, Tex. In another example, the NMR measurements may be made using an instrument identified by the trademark CMR, which is also a mark of Schlumberger Technology Corporation. The NMR instrument, irrespective of type, is generally moved longitudinally along the wellbore and a record with respect to depth in the wellbore is made of the NMR properties of the various formations. The foregoing identified MR SCANNER instrument, in particular, can make measurements of NMR properties of the formations at a plurality of different, defined lateral depths of investigation. The lateral depths of investigation for the foregoing instrument are about 1.5 inches (3.8 cm), 2.7 inches (6.9 cm) and 4 inches (10.2 cm) from the wall of the wellbore. As explained above, the lateral depth of investigation of any particular NMR measurement is defined by the spatial distribution of the amplitude of the static magnetic field and the frequency of the RF magnetic field used to excite NMR phenomena. The example instruments described herein are not limitations on the scope of this invention but are provided only to illustrate the principle of the invention.

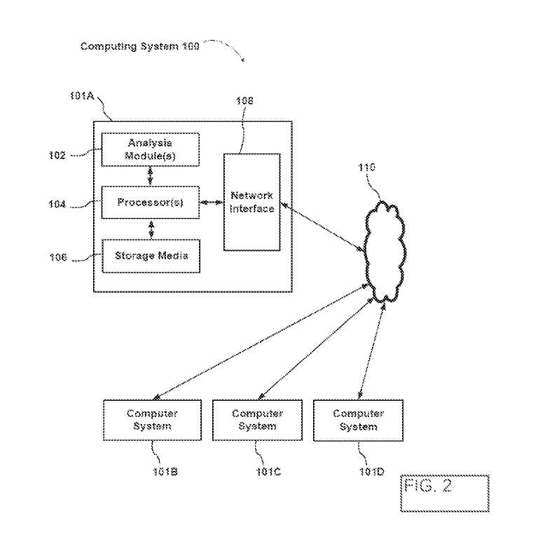

FIG. 2 shows an example computing system 100 in accordance with some embodiments. The computing system 100 can be an individual computer system 101A or an arrangement of distributed computer systems. The computer system 101A includes one or more analysis modules 102 that are configured to perform various tasks according to some embodiments, such as will be further explained below. To perform these various tasks, analysis module 102 executes independently, or in coordination with, one or more processors 104, which is (or are) connected to one or more storage media 106. The processor(s) 104 is (or are) also connected to a network interface 108 to allow the computer system 101A to communicate over a data network 110 with one or more additional computer systems and/or computing systems, such as 101B, 101C, and/or 101D (note that computer systems 101B, 101C and/or 101D may or may not share the same architecture as computer system 101A, and may be located in different physical locations, e.g. computer systems 101A and 101B may be on a ship underway on the ocean, while in communication with one or more computer systems such as 101C and/or 101D that may be located in one or more data centers on shore, other ships, and/or located in varying countries on different continents).

A processor can include a microprocessor, microcontroller, processor module or subsystem, programmable integrated circuit, programmable gate array, or another control or computing device.

The storage media 106 may be be implemented as one or more computer-readable or machine-readable storage media. Note that while in the exemplary embodiment of FIG. 2 storage media 106 is depicted as within computer system 101A, in some embodiments, storage media 106 may be distributed within and/or across multiple internal and/or external enclosures of computing system 101A and/or additional computing systems. Storage media 106 may include one or more different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; optical media such as compact disks (CDs) or digital video disks (DVDs); or other types of storage devices. Note that the instructions discussed above can be provided on one computer-readable or machine-readable storage medium, or alternatively, can be provided on multiple computer-readable or machine-readable storage media distributed in a large system having possibly plural nodes. Such computer-readable or machine-readable storage medium or media is (are) considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

It should be appreciated that computing system 100 is only one example of a computing system, and that computing system 100 may have more or fewer components than shown, may combine additional components not depicted in the exemplary embodiment of FIG. 2, and/or computing system 100 may have a different configuration or arrangement of the components depicted in FIG. 2. The various components shown in FIG. 2 may be implemented in hardware, software, or a combination of both hardware and software, including one or more signal processing and/or application specific integrated circuits.

Further, the steps in the processing methods described above may be implemented by running one or more functional modules in information processing apparatus such as general purpose processors or application specific chips, such as ASICs, FPGAs, PLDs, or other appropriate devices. These modules, combinations of these modules, and/or their combination with general hardware are all included within the scope of the present disclosure.

U.S. Patent Application Publication No. 2010/0315081 filed by Chanpura et al. and incorporated herein by reference describes a method for determining particle size distribution of subsurface formations penetrated by a wellbore by making measurements of NMR relaxation times (either transverse or longitudinal) and NMR diffusion properties. The method disclosed in the '081 publication uses the assumption that the pore spaces of the formation being evaluated are saturated with water. The description below will explain example techniques for the situation where the pore spaces are not completely water-filled.

In a single fluid saturated rock, the fluid interacts with the entire rock grain surface area. One may define the entire surface area of the rock grains, and the pore volume V^{P}. T2 of the fluid reflects the ratio Σ/V_{P}. In a mixed saturation case, at least two fluids are in the pore spaces of the rock formation, each occupying part of Σ and V^{P}. The present description will use a specific example of formation saturated with brine and oil, with the brine and oil saturation (fractional volume of the total pore space) represented by S_{w}, and 1−S_{w}, respectively. Similarly, the rock-contacting area of the two different fluids are Σ_{w}, and Σ−Σ_{w}, respectively. The NMR transverse relaxation time in each fluid is proportional to the respective surface-to-volume ratio:

$$\frac{1}{{T}_{2 w}} - \frac{1}{{T}_{2 wb}} = {ρ}_{2 w} \frac{{\sum }_{w}^{ } }{{V}_{w}} \\ and \\ \frac{1}{{T}_{2 o}} - \frac{1}{{T}_{2 ob}} = {ρ}_{2 o} \frac{{\sum }_{o}^{ } }{{V}_{o}} . \qquad [ 1 ]$$

wherein the parameter ρ₂ represents the surface relaxivity determined using measurements of diffusion constant (D) and transverse relaxation time (T2) as fully explained in the '081 publication cited herein above. Because ρ₂ can be obtained by DT2 mapping as explained in the foregoing publication, one may obtain the surface-to-volume ratio for each of the oil and rock filled pore spaces by the following expressions:

$$\frac{{\sum }_{w}^{ } }{{V}_{w}} = ( \frac{1}{{T}_{2 w}} - \frac{1}{{T}_{2 wb}} ) \frac{1}{{ρ}_{2 w}} \\ and \\ \frac{{\sum }_{o}^{ } }{{V}_{o}} = ( \frac{1}{{T}_{2 o}} - \frac{1}{{T}_{2 ob}} ) \frac{1}{{ρ}_{2 o}} \qquad [ 2 ]$$

The subscripts w and o represent the brine and oil, respectively. The subscript b represents a bulk value for each of the oil and brine, e.g., T2wb is bulk T2 of brine.

From the method set forth in the '081 publication, it may be possible to determine the total surface-to-volume ratio (in both the brine and oil saturated pore spaces) in order to derive the particle size distribution. Thus, this quantity can be obtained by the following formula:

$$\begin{matrix}\frac{\sum }{{V}_{p}} = \frac{{\sum }_{o}^{ } + {\sum }_{w}^{ }}{{V}_{p}} \\ = \frac{{\sum }_{o}^{ }}{{V}_{o}} ( 1 - {S}_{w} ) + \frac{{\sum }_{w}^{ }}{{V}_{w}} {S}_{w}\end{matrix} \qquad [ 3 ]$$

From Eq. 3, it may be observed that the total surface-to-volume ratio may be obtained from the measurements of surface-to-volume ratio of each of the oil and brine filled pore spaces and the water (or oil) saturation. Once Σ/V_{P} is obtained for each of the oil and brine filled pore spaces, the method described in the '081 publication may be used to obtain the particle size distribution.

The following are several scenarios that could simplify the above equation and also may be more relevant to certain subsurface formations.

1. When the oil saturation is very low, such as often the case in the invaded zone (see Sxo in FIG. 1A) of loosely consolidated formations, Sw≈1 and 1−Sw≈0, therefore the oil phase contribution to Eq. 3 is very small, and thus:

$$\frac{\sum }{{V}_{p}} \approx \frac{{\sum }_{w}^{ }}{{V}_{w}} {S}_{w} \qquad [ 4 ]$$

In the above case, the predominant contribution to the D and T2 measurements is from the water (brine) phase and it is possible to ignore the oil contribution to the NMR measurements to determined the particle size distribution. For wells drilled with drilling fluid in which water is the continuous phase (water based mud—WBM), the foregoing is often applicable.

2. In a water wet formation, i.e., where water is the wetting phase in contact with the formation rock mineral grains, the oil phase does not come in contact with the rock mineral grain surfaces, and thus Eq. 3 can also be simplified to Eq. 4. In such cases the total Σ/V_{P} is dominated by the water contribution to the NMR measurements. In such case, however, it is necessary to obtain an accurate measurement of the water or oil saturation in order to use Eq. 4. Sw (water saturation) can be obtained from NMR measurements, dielectric measurements, or shallow depth of investigation formation resistivity measurements (e.g., interpreted with the appropriate exponents for the Archie water saturation equation).

When the oil saturation is high, the NMR measurement response may correspond to the case of high water saturation and Eq. 4 may be used, except that in Eq. 4 the relaxation parameter of the oil would be used.

In some formations (often carbonate rocks) a large range of pore and grain sizes exists, and respective fluid saturations can be drastically different within different pore sizes (correspondingly in different grain size regions). For example, in some carbonate formations some of the grains are self porous (often called microporosity) and the oil saturation is typically high in the large pores and essentially zero in the small pores. Such rock formation pore structure is often the result of extensive diagenesis and the resulting rock formations are typically very strong. As a result, the it is unlikely such formation will cause significant rock particle movement into the wellbore during production of fluids from the formation.

In the case above, the following method can be used to derive the particle size distribution. From Eq. 3, one may take an average of the oil contribution to the NMR measurements:

$$\begin{matrix}\frac{\sum }{{V}_{p}} = \frac{{\sum }_{o}^{ } }{{V}_{o}} ( 1 - {S}_{w} ) + \frac{{\sum }_{w}^{ } }{{V}_{w}} {S}_{w} \\ \approx \frac{{\sum }_{w}^{ } }{{V}_{w}} {S}_{w} + 〈 \frac{{\sum }_{o}^{ }}{{V}_{o}} ( 1 - {S}_{w} ) 〉 \\ \approx \frac{{\sum }_{w}^{ } }{{V}_{w}} {S}_{w} + \frac{( 1 - {S}_{w} )}{{ρ}_{2 o}} 〈 \frac{1}{{T}_{2 o}} - \frac{1}{{T}_{2 ob}} 〉\end{matrix} \qquad [ 5 ]$$

where the angle brackets represent the average. Thus the first term is the brine contribution and the second term is a constant related to the oil contribution to the NMR measurement response. Because the second term in Eq. 5 is a constant independent of respective fluid saturation (Sw; So), its effect on the smaller pores is correspondingly reduced compared to that in the larger pores. This approximation compensates the reduction of oil saturation is smaller pores.

One issue due to the simple treatment of the oil saturation may overestimate the oil saturation in the small pore due to the first term in Eq. 5. One may improve the results of such overestimation by applying a cutoff (limiting) pore size so that the oil saturation below the cutoff pore size is assumed to be zero. Other saturation models can also be used to improve Eq. 5.

A potential problem exists with respect to the bulk T2 for water and oil. It is important to obtain the bulk T1 or T2 of water at the downhole temperature and the actual salinity of the formation water. This topic has been studied well and discussed in detailed in Denise E. Freed, THE JOURNAL OF CHEMICAL PHYSICS 126, 174502, (2007), Dependence on chain length of NMR relaxation times in mixtures of alkanes.

It may also be important to obtain the bulk relaxation time of crude oil under actual downhole conditions (temperature, pressure, composition such as gas content and gas-oil ratio). Several methods can be used to obtain the bulk value including laboratory measurement of the oil under simulated downhole conditions; extraction of a crude oil sample at downhole conditions by a system such as a fluid test instrument sold under the trademark MDT (which is a trademark of Schlumberger Technology Corporation) to acquire crude oil samples from the uninvaded zone (e.g., refer to FIG. 1A). An NMR module could be included in such instrument (e.g., the MDT instrument) to measure the fluid sample NMR response under downhole conditions.

In addition, once the composition of the formation oil is known or determined, its NMR behavior can be calculated using a method as described in the Freed publication cited above, or through comparison with other oils in a database.

The foregoing description relates to measurements of NMR properties of subsurface formations made from within a wellbore drilled or being drilled through the formations. It is to be understood that laboratory measurements of NMR properties may also be used in order example implementations of a method as disclosed herein.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A method for determining particle size distribution of a subsurface rock formation having pore spaced filled with at least two different fluids using measurements of at least one nuclear magnetic resonance property thereof, comprising:
in a computer, determining a distribution of nuclear magnetic relaxation times from the measurements of the at least one nuclear magnetic resonance property;
in the computer, determining a fractional volume of the pore spaces occupied by each of the at least two fluids;
in the computer, determining a surface relaxivity of the rock formation for portions of the rock pore spaces occupied by each of the at least two fluids from a measurement of a formation parameter; and
in the computer, using the relaxation time distribution and the surface relaxivities to determine the particle size distribution.

2. The method of claim 1 wherein the formation parameter comprises a diffusion property of the rock formation.

3. The method of claim 2 wherein the diffusion property with respect to relaxation time is related to a molecular diffusion constant of each of the at least two fluids disposed in the pore spaces of the rock formation.

4. The method of claim 2 further comprising determining a Padé interpolated formulation of the diffusion property for each of the at least two fluids.

5. The method of claim 1 wherein the formation parameter comprises particle size analysis of samples of the rock formation.

6. The method of claim 1 wherein the nuclear magnetic relaxation times comprise either transverse nuclear magnetic relaxation times or longitudinal nuclear magnetic relaxation times.

7. The method of claim 1 wherein the at least two fluids comprise water, oil and mixtures of gas and oil.

8. The method of claim 1 further comprising selecting a cutoff pore size below which a fractional volume of the second of the at least two fluids is assumed to be zero.

9. The method of claim 1 further comprising correcting bulk values of relaxation time for at least one of the first fluid and the second fluid by measuring nuclear relaxation properties of the at least one of the first fluid and the second fluid at downhole conditions.

10. The method of claim 9 wherein the measuring at downhole conditions comprises withdrawing a sample of the at least one of the first fluid and the second fluid from within a wellbore at a depth of a formation containing the at least one of the first fluid and second fluid and making nuclear magnetic resonance measurements thereof at pressure and temperature conditions at the depth of the formation.

11. The method of claim 1 wherein the determining fractional volumes comprises measuring electrical resistivity of the subsurface rock formation.

12. A method for determining particle size distribution of a subsurface rock formation, comprising:
moving a nuclear magnetic resonance well logging instrument along a wellbore drilled through the subsurface rock formation;
measuring at least one nuclear magnetic resonance property of the rock formation using the instrument;
in a computer, determining a distribution of nuclear magnetic relaxation times from the measurements of the at least one nuclear magnetic resonance property;
in the computer, determining a fractional volume of the pore spaces occupied by each of the at least two fluids;
in the computer, determining a surface relaxivity of the rock formation for portions of the rock pore spaces occupied by each of the at least two fluids from a measurement of a formation parameter; and
in the computer, using the relaxation time distribution and the surface relaxivities to determine the particle size distribution.

13. The method of claim 12 wherein the formation parameter comprises a diffusion property of the rock formation.

14. The method of claim 13 wherein the diffusion property with respect to relaxation time is related to a molecular diffusion constant of each of the at least two fluids disposed in the pore spaces of the rock formation.

15. The method of claim 13 further comprising determining a Padé interpolated formulation of the diffusion property for each of the at least two fluids.

16. The method of claim 12 wherein the formation parameter comprises particle size analysis of samples of the rock formation.

17. The method of claim 12 wherein the nuclear magnetic relaxation times comprise transverse nuclear magnetic relaxation times or longitudinal nuclear magnetic relaxation times.

18. The method of claim 12 wherein the at least two fluids comprise water, oil and mixtures of gas and oil.

19. The method of claim 12 further comprising selecting a cutoff pore size below which a fractional volume of the second of the at least two fluids is assumed to be zero.

20. The method of claim 12 further comprising correcting bulk values of relaxation time for at least one of the first fluid and the second fluid by measuring nuclear relaxation properties of the at least one of the first fluid and the second fluid at downhole conditions.

21. The method of claim 12 wherein the measuring at downhole conditions comprises withdrawing a sample of the at least one of the first fluid and the second fluid from within a wellbore at a depth of a formation containing the at least one of the first fluid and second fluid and making nuclear magnetic resonance measurements thereof at pressure and temperature conditions at the depth of the formation.

22. The method of claim 12 wherein the determining fractional volumes comprises measuring electrical resistivity of the subsurface rock formation.

23. The method of claim 12 wherein the moving the instrument comprises moving an armored electrical cable through the wellbore, the instrument disposed proximate one end of the cable.

24. The method of claim 12 wherein the moving the instrument comprises moving a pipe through the wellbore, the instrument coupled within the pipe.

25. The method of claim 12 wherein the particle size distribution is used to determine at least one parameter related to completion of the wellbore.

26. The method of claim 25 wherein the parameter related to completion comprises at least one of completion device type, completion screen opening or mesh size and gravel size.
